(19) United States
(12) Patent Application Publication
(10) Pub. No.: US 2026/0259456 A1
(43) Pub. Date: Sep. 3, 2026

(54) DISPLAY SUBSTRATE AND PREPARATION METHOD THEREOF, DISPLAY PANEL AND DISPLAY APPARATUS

(71) Applicants: BEIJING BOE TECHNOLOGY DEVELOPMENT CO., LTD., Beijing (CN); BOE Technology Group Co., Ltd., Beijing (CN)

(72) Inventors: Yong Yu, Beijing (CN); Shi Shu, Beijing (CN); Feifei Li, Beijing (CN); Shaopeng Yang, Beijing (CN); Chuanxiang Xu, Beijing (CN); Xiang Li, Beijing (CN); Yang Yue, Beijing (CN); Shaohui Li, Beijing (CN); Xinhua Liu, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/993,161

(22) PCT Filed: Sep. 4, 2023
(86) PCT No.: PCT/CN2023/116665

§ 371 Date: Jan. 10, 2025

(51) Int. Cl. G02F 1/1339; G02F 1/1335

(52) U.S. Cl. CPC G02F 1/13396; G02F 1/133512

(57) ABSTRACT

A display substrate and a preparation method thereof, a display panel, and a display apparatus are provided, which relate to the technical field of a display. The display substrate includes a base substrate and a plurality of support pillars disposed on a side surface of the base substrate, and the support pillars have a first surface close to the base substrate and a second surface opposite to the first surface. In any direction parallel to the substrate, a ratio of a width of the first surface to a width of the second surface is greater than or equal to 0.8, and less than or equal to 1.2, and the width of the first surface is greater than or equal to 0.8 micrometers and less than or equal to 3 micrometers.

### TECHNICAL FIELD

The present disclosure relates to the technical field of a display, and in particular to a display substrate and a preparation method thereof, a display panel, and a display apparatus.

### BACKGROUND

With the development of display technology, the pixels per inch (PPI) of the display panel is required to be higher and higher. The resolution of the display panel has gradually increased from 200 PPI to 500 PPI, 1000 PPI and 1500 PPI. Even in the fields of augmented reality (AR) and virtual reality (VR), the resolution of the display panel is required to reach 1000 PPI or even 2000 PPI or more, which puts higher requirements on the design and manufacturing of the display panel.

### SUMMARY

The present disclosure provides a display substrate, including:
a base substrate; and
a plurality of support pillars disposed on a side surface of the base substrate, wherein the support pillars have a first surface close to the base substrate and a second surface opposite to the first surface; and
in any direction parallel to the base substrate, a ratio of a width of the first surface to a width of the second surface is greater than or equal to 0.8 and less than or equal to 1.2, and the width of the first surface is greater than or equal to 0.8 micrometers and less than or equal to 3 micrometers.

In some implementations, the plurality of support pillars includes a first support pillar and a second support pillar, a height of the first support pillar in a first direction is greater than a height of the second support pillar in the first direction, and the first direction is a direction from the base substrate to the second surface of the support pillars.

In some implementations, a light-shielding layer is disposed between the base substrate and the support pillars, and the light-shielding layer includes a plurality of light-shielding patterns; and
an orthographic projection of at least one of the support pillars on the base substrate is located in an orthographic projection of one of the light-shielding patterns on the base substrate, and in orthographic projections on the base substrate, the support pillar is centrally disposed within the light-shielding patterns overlapping with the support pillars.

In some implementations, the support pillars include:
an inner pillar and an outer pillar, the outer pillar is disposed around a periphery of the inner pillar, the outer pillar is disposed close to a side surface of the support pillars, and a density of the outer pillar is less than that of the inner pillar.

In some implementations, the support pillars include:
a plurality of sub-pillars stacked sequentially in the first direction, at least two of the sub-pillars have different features comprising at least one of a size of holes on a side surface of the sub-pillars, a density of holes on the side surface of the sub-pillars, a lateral inclination angle of the sub-pillars, and a size of the sub-pillars in the second direction, the lateral inclination angle is an angle between the side surface of the sub-pillars and the first direction, the first direction is a direction from the base substrate to the second surface of the support pillars, and the second direction is perpendicular to the first direction; and
the plurality of sub-pillars includes a first sub-pillar, a second sub-pillar and a third sub-pillar, the first sub-pillar is disposed close to the base substrate, the third sub-pillar is disposed away from the base substrate, and the second sub-pillar is disposed between the first sub-pillar and the third sub-pillar.

In some implementations, a size of holes on a side surface of the second sub-pillar is greater than or equal to a size of holes on a side surface of the first sub-pillar, and the size of holes on the side surface of the first sub-pillar is greater than or equal to a size of holes size on a side surface of the third sub-pillar.

In some implementations, a density of holes on the side surface of the second sub-pillar is less than or equal to a density of holes on the side surface of the first sub-pillar, and a density of holes on the side surface of the first sub-pillar is less than or equal to a density of holes on the side surface of the third sub-pillar.

In some implementations, a lateral inclination angle of the second sub-pillar is less than or equal to a lateral inclination angle of the first sub-pillar, and the lateral inclination angle of the first sub-pillar is less than or equal to a lateral inclination angle of the third sub-pillar.

In some implementations, the lateral inclination angle is greater than or equal to 0° and less than or equal to 30°.

In some implementations, a size of the second sub-pillar in the second direction is less than or equal to a size of the first sub-pillar in the second direction, and the size of the first sub-pillar in the second direction is less than or equal to a size of the third sub-pillar in the second direction; or
the size the first sub-pillar in the second direction is less than or equal to the size of the second sub-pillar in the second direction, and the size of the second sub-pillar in the second direction is less than or equal to the size of the third sub-pillar in the second direction.

In some implementations, the support pillars include at least one of:
a boss, disposed at an edge of a surface of the support pillars away from the base substrate, and recessed toward a side close to the base substrate; and
a slit, close to a position where the side surface of the support pillars intersects the first surface.

In some implementations, in orthographic projections on the base substrate, a ratio of a minimum distance between an edge of the support pillars and an edge of the light-shielding patterns, to heights of the support pillars in the first direction, is greater than or equal to 1/1.2 and less than or equal to 1, and the first direction is a direction from the base substrate to the second surface of the support pillars.

In some implementations, a host material of the light-shielding layer is a metallic material.

In some implementations, in orthographic projections on the base substrate, a minimum distance between an edge of the first support pillar and an edge of the light-shielding patterns is substantially equal to a minimum distance between an edge of the second support pillar and the edge of the light-shielding patterns.

In some implementations, a height of the support pillars in the first direction is greater than or equal to 1.0 micrometers and less than or equal to 1.6 micrometers; and/or
a ratio of a size of the support pillars in the second direction to the height of the support pillars in the first direction is greater than or equal to 1/1.3; and
the first direction is a direction from the base substrate to the second surface of the support pillars, and the second direction is perpendicular to the first direction.

In some implementations, the first support pillar includes a third surface which is a surface of the first support pillar away from the base, the second support pillar includes a fourth surface which is a surface of the second support pillar away from the base substrate, and a roughness of the third surface is less than or equal to a roughness of the fourth surface.

In some implementations, the display substrate includes a plurality of sub-pixels, a number of sub-pixels disposed between two adjacent first support pillars is greater than or equal to 10 and less than or equal to 20, and a number of sub-pixels disposed between two adjacent second support pillars is greater than or equal to 1 and less than or equal to 2.

The present disclosure provides a display panel, including: a cell substrate, a liquid crystal layer, and the display substrate according to any item, wherein the liquid crystal layer is disposed between the cell substrate and the display substrate, and the support pillars are disposed close to the liquid crystal layer; and
the cell substrate includes a cell base, and a plurality of bosses disposed on a side of the cell substrate close to the liquid crystal layer, and the plurality of bosses are disposed opposite different support pillars.

The present disclosure provides a display panel, including:
the display substrate according to any item; and
a plurality of light-emitting devices, wherein in orthographic projections on the base substrate, the support pillars are disposed between two adjacent light-emitting devices.

The present disclosure provides a display apparatus, comprising:
the display panel according to any item; and
a driving component, connected to the display panel and configured for driving the display panel to display a picture.

The present disclosure provides a preparation method of a display substrate, including:
providing a base substrate;
forming a light-shielding layer and a plurality of support pillars on a side of the base substrate, wherein the plurality of support pillars are disposed on a surface of the light-shielding layer away from the base substrate, the light-shielding layer includes a plurality of light-shielding patterns, in orthographic projections on the base substrate, different support pillars are disposed in different light-shielding patterns, and shapes of the support pillars and the light-shielding patterns overlapping with each other are substantially the same shape, the plurality of support pillars include a first support pillar and a second support pillar, a height of the first support pillar in a first direction is greater than a height of the second support pillar in the first direction, and the first direction is a direction from the base substrate to the light-shielding layer.

In some implementations, the forming the light-shielding layer and the plurality of support pillars on the side of the base substrate includes:
forming a light-shielding film on a side of the base substrate;
forming a support film on a side of the light-shielding film away from the base substrate;
forming a mask pattern on a side of the support film away from the base substrate by a patterning process;
etching the support film not covered with the mask pattern to form a plurality of support patterns;
etching the light-shielding film not covered with the mask pattern to form a plurality of light-shielding patterns, so as to obtain the light-shielding layer;
transversely etching the plurality of support patterns to form a third support pillar and a fourth support pillar;
covering a protective film on a side of the third support pillar, a mask pattern connected with the third support pillar, and a light-shielding pattern connected with the third support pillar away from the base substrate;
removing the mask pattern connected with the fourth support pillar;
removing the protective film;
longitudinally etching the fourth support pillar to obtain the second support pillar; and
removing the mask pattern connected with the third support pillar to obtain the first support pillar.

The above description is only a summary of technical schemes of the present disclosure, which can be implemented according to contents of the specification in order to better understand technical means of the present disclosure; and in order to make above and other objects, features and advantages of the present disclosure more obvious and understandable, detailed description of the present disclosure is particularly provided in the following.

### BRIEF DESCRIPTION OF THE DRAWINGS

In order to explain the technical solution of the implementations of the present disclosure more clearly, the drawings required in the description of the implementations of the present disclosure may be briefly introduced below; obviously, the drawings in the following description are some implementations of the present disclosure, and for those of ordinary skill in the art, other drawings can be obtained according to these drawings without paying creative labor. It should be noted that the scale in the drawings is only for illustration and does not represent the actual scale.

FIG. 1 exemplarily illustrates a schematic structure diagram of a display panel in the conventional technology;

FIG. 2 exemplarily illustrates a schematic diagram of a cross-sectional structure of a display substrate according to the present disclosure;

FIG. 3 exemplarily illustrates a schematic diagram of a planar structure of a display substrate according to the present disclosure;

FIG. 4 exemplarily illustrates a schematic diagram of several planar structures of a light-shielding pattern and a support pillar;

FIG. 5 illustrates exemplarily a schematic diagram of a planar structure of a support pillar in diagram a, and illustrate two cross-sectional electron micrographs of the support pillar in diagrams b and c;

FIG. 6 exemplarily illustrates a schematic diagram of cross-sectional structures of two display substrates;

FIG. 7 exemplarily illustrates a schematic diagram of a cross-sectional structure of a support pillar;

FIG. 8 exemplarily illustrates a schematic diagram of a cross-sectional structure of a display panel in a first state;

FIG. 9 exemplarily illustrates a schematic diagram of a cross-sectional structure of a display panel in a second state;

FIG. 10 exemplarily illustrates a schematic diagram of a cross-sectional structure of a counter substrate;

FIGS. 11 and 12 exemplarily illustrate flowcharts of a preparation method of a display substrate;

FIG. 13 exemplarily illustrates a schematic diagram of a planar structure of another display panel; and

FIG. 14 exemplarily illustrates a schematic diagram of a cross-sectional structure of another display panel.

### DETAILED DESCRIPTION OF THE IMPLEMENTATIONS

In order to make the objects, the technical solutions and the advantages of the implementations of the present disclosure clearer, the technical solutions of the implementations of the present disclosure may be clearly and completely described below with reference to the drawings of the implementations of the present disclosure. Apparently, the described implementations are merely certain implementations of the present disclosure, rather than all of the implementations. All of the other implementations that a person skilled in the art obtains on the basis of the implementations of the present disclosure without paying creative work fall within the protection scope of the present disclosure.

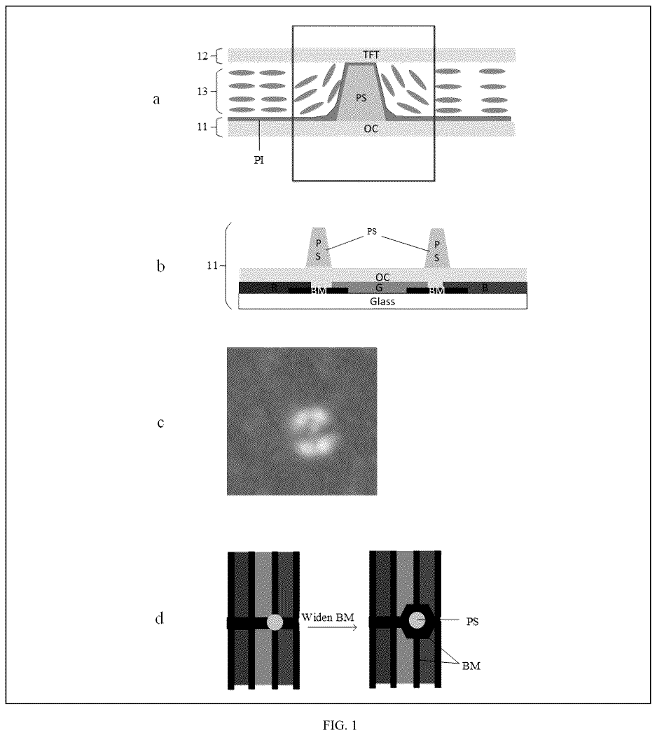

In the conventional technology, as shown in diagram a in FIG. 1, a liquid crystal display panel generally includes a color filter substrate 11, an array substrate 12, and liquid crystal molecules 13 filled between the color filter substrate 11 and the array substrate 12. As shown in diagram b in FIG. 1, the color filter substrate 11 includes a glass substrate Glass, a black matrix BM, a color resist layer R/G/B, a flattening layer OC, and a spacer PS, which are stacked sequentially. In the liquid crystal display panel, as shown in diagram a in FIG. 1, the spacer PS is provided between the color filter substrate 11 and the array substrate 12 for supporting the cell gap between the color filter substrate 11 and the array substrate 12 to make the cell gap uniform.

As shown in diagram a in FIG. 1, the color filter substrate 11 is usually provided with an alignment film PI on a surface close to the liquid crystal layer. Because the alignment film PI is accumulated around the spacer PS and is affected by the morphology of the spacer PS, the alignment of the liquid crystal molecules 13 around the spacer PS is disordered, resulting in light leakage around the spacer PS, as shown in diagram c in FIG. 1.

In the conventional technology, a size BM CD1 of the black matrix BM below PS is usually widened in order to block the light leakage around PS. The size BM CD1 of the black matrix BM below PS is calculated using the following formula:

$$BM CD 1 = PS CD 1 + 2 * LLD 1 + 2 * \sqrt{BM tol {1}^{2} + PS tol {1}^{2} + ol {1}^{2}}$$

where PS CD1 is a maximum size of the spacer PS in the direction parallel to a plane where the glass substrate Glass is located, LLD1 is a maximum distance between a boundary of a light leakage region around the spacer PS and the spacer PS, i.e., a light leakage distance, BM tol1 is size tolerance of the black matrix BM in the direction parallel to the plane where the glass substrate Glass is located, and PS tol1 is size tolerance of the spacer PS in the direction parallel to the plane where the glass substrate Glass is located, and ol1 is alignment tolerance between the spacer PS and the black matrix BM.

It may be seen that in order to block light leakage around the spacer PS, the widened size of the black matrix BM causes a large loss to an aperture rate of the display substrate, as shown in diagram d in FIG. 1. Especially in high PPI display substrates, the effect of the widened size of the black matrix BM on the aperture rate cannot be ignored.

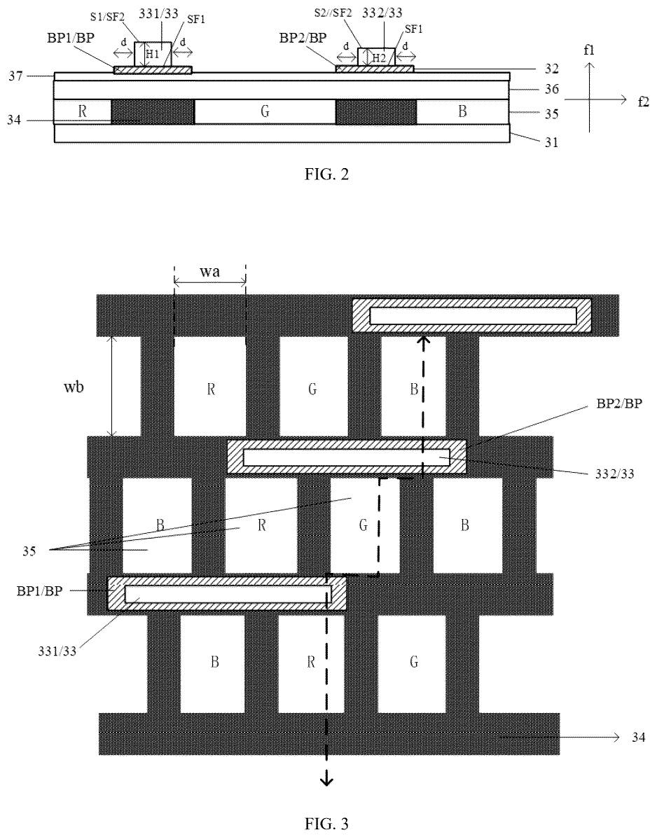

In order to solve the above problem, the present disclosure provides a display substrate, as shown in FIG. 2, which includes: a base substrate 31 and a plurality of support pillars 33 provided on a side surface of the base substrate 31, and the support pillars 33 have a first surface SF1 close to the base substrate 31, and a second surface SF2 opposite to the first surface.

In any direction parallel to the base substrate 31, a ratio of a width of the first surface SF1 to a width of the second surface SF2 is greater than or equal to 0.8 and less than or equal to 1.2, and a width of the first surface SF1 is greater than or equal to 0.8 micrometers and less than or equal to 3 micrometers.

In some implementations, as shown in FIG. 2, the plurality of support pillars 33 include a first support pillar 331 and a second support pillar 332, a height H1 of the first support pillar 331 in a first direction f1 is greater than a height H2 of the second support pillar 332 in the first direction f1, and the first direction f1 is a direction from the base substrate 31 to the second surface SF2 of the support pillars 33.

In some implementations, as shown in FIG. 2 or FIG. 3, a light-shielding layer 32 is provided between the base substrate 31 and the support pillars 33, the light-shielding layer 32 includes a plurality of light-shielding patterns BP, and an orthographic projection of at least one of the support pillars on the base substrate is located in one of light-shielding patterns.

Exemplarily, as shown in FIG. 2 or FIG. 3, different support pillars 33 are located in different light-shielding patterns BP in the orthographic projection on the base substrate 31, and the support pillars 33 overlapping with each other have substantially the same shape as the light-shielding patterns BP.

Exemplarily, as shown in FIG. 2 or FIG. 3, in the orthographic projection on the base substrate, the support pillars are centrally disposed in the light-shielding patterns overlapping with the support pillars.

As shown in FIG. 2 or FIG. 3, for the support pillars 33 and the light-shielding patterns BP whose orthographic projections on the base substrate 31 overlap each other, orthographic projection edges of the support pillars 33 are located within orthographic projection edges of the light-shielding patterns BP, i.e., the edges of the support pillars 33 are indented with respect to the edges of the light-shielding patterns BP.

Exemplarily, a size BP CD2 of the light-shielding patterns BP in the second direction f2 may be calculated using the following formula:

$$BP CD 2 = PS CD 2 + 2 * LLD 2 + 2 * \sqrt{BP tol {2}^{2} + PS tol {2}^{2} + ol {2}^{2}} ,$$

where the second direction f2 is perpendicular to the first direction f1, i.e., the second direction f2 is any direction parallel to the plane where the base substrate 31 is located. PS CD2 is a maximum size of the support pillars 33 in the second direction f2, LLD2 is a maximum distance between a boundary of the light leakage region around the support pillars 33 and the support pillars 33, i.e., a light leakage distance, BP tol2 is size tolerance of the light-shielding pattern BP in the second direction f2, PS tol2 is size tolerance of the support pillars 33 in the second direction f2, and ol2 is alignment tolerance between the support pillars 33 and the light-shielding patterns BP.

In the display substrate provided in the present disclosure, since the support pillars 33 are directly provided on a surface of the light-shielding layer 32 away from the base substrate 31, and no film layer such as the light-filtering layer 35 and the flattening layer 36 are provided between the support pillars 33 and the light-shielding layer 32, the distance between the liquid crystal layer 82 and the light-shielding layer 32 in the display panel may be reduced (as shown in FIG. 8), thereby reducing the diffusion range of the light leakage around the support pillars 33 in the transverse direction (i.e., in the second direction f2), i.e., reducing the light leakage distance LLD2 in the above calculation formula, reducing the transverse size BP CD2 of the light-shielding patterns BP, reducing the decrease in the aperture rate due to the blocking of the light leakage around the support pillars 33, and improving light transmittance of the display substrate.

Exemplarily, the light-shielding layer 32 and the support pillars 33 may be formed by a self-alignment process, i.e., the light-shielding layer 32 and the support pillars 33 are exposed and etched using the same mask. Compared to a process in which the light-shielding layer 32 and the support pillars 33 are photolithographed using different masks, the self-alignment process saves a mask process, simplifies the preparation process, and reduces the cost. In the self-alignment process, transverse etching may be used to indent the edges of the support pillars 33 with respect to the edges of the light-shielding patterns BP.

With the self-alignment process, the alignment between the light-shielding patterns BP and the support pillars 33 may be avoided, so that the alignment tolerance ol2 may be eliminated, the transverse size BP CD2 of the light-shielding patterns BP may be reduces, the decrease in the aperture rate due to blocking the light leakage around the support pillars 33 may be reduces, and the light transmission of the display substrate may be improved.

With the self-alignment process, the size BP CD2 of the light-shielding patterns BP in the second direction f2 may be calculated using the following formula: BP CD2=PS CD2+2*LLD2+2*\sqrt{BP tol2²}. Based on the calculation with ol2=0.6 micrometers and PS tol2=0.5 micrometers, the display substrate provided in the present disclosure is prepared by the self-alignment process, which may reduce the transverse size BP CD2 of the light-shielding patterns BP by 0.86 micrometers.

As the resolution of the display substrate increases, the size of each sub-pixel decreases. The resolution is calculated at 2000 PPI, and the size of each pixel is, for example, 12.7 micrometers. Accordingly, the size of each sub-pixel is 4.2 μm, and each sub-pixel is provided with a necessary device such as a thin film transistor TFT, so the aperture rate of a high-resolution display substrate is relatively low. The display substrate provided in the present disclosure is conducive to realizing high resolution, such as 2000 PPI or more, and may be applied in AR or VR display products that require high resolution.

Exemplarily, as shown in FIG. 3, each sub-pixel may have a width wa of, for example, 4.2 μm and a length wb of, for example, 12.7 micrometers.

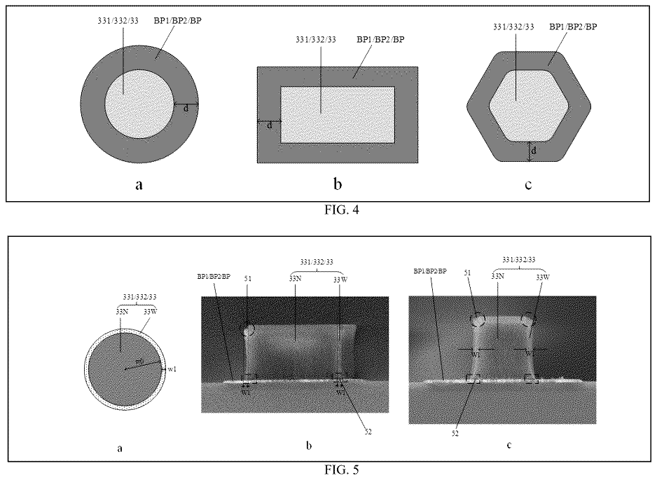

Exemplarily, as shown in FIG. 4, shapes of the orthographic projections of the light-shielding patterns BP on the base substrate 31 may include at least one of regular or irregular patterns such as a circle (as shown in diagram a in FIG. 4), an ellipse, a waist circle, and a polygon. The polygon may be, for example, a triangle, a quadrilateral such as a rectangle (as shown in diagram b in FIG. 4), a trapezoid, a pentagon, a hexagon (as shown in diagram c in FIG. 4), etc. The polygon may be, for example, a chamfered polygon (as shown in diagram c in FIG. 4) or a non-chamfered polygon.

Exemplarily, shapes of the orthographic projections of the support pillars 33 on the base substrate 31 may include at least one of regular or irregular patterns such as a circle (as shown in diagram a in FIG. 4), an ellipse, a waist circle, a polygon. The polygon may be, for example, a triangle, a quadrilateral such as a rectangle (as shown in diagram b in FIG. 4), a trapezoid, a pentagon, a hexagon (as shown in diagram c in FIG. 4), etc. The polygon may be, for example, a chamfered polygons (as shown in diagram c in FIG. 4) or a non-chamfered polygon.

Exemplarily, with the self-alignment process, light-shielding patterns BP and support pillars 33 with the same shape may be prepared, as shown in FIG. 4.

In some implementations, as shown in FIGS. 2 to 4, the orthographic projections of the support pillars 33 are centrally disposed in the orthographic projections of the light-shielding patterns BP overlapping with the support pillars 33 on the base substrate 31.

Exemplarily, orthographic projections of different side edges of the support pillars 33 are indented by approximately the same amount with respect to orthographic projections the edges of the light-shielding patterns BP overlapping with the support pillars 33 on the base substrate 31, and as shown in FIGS. 2 to 4, the indentation amounts are d.

Exemplarily, as shown in FIGS. 2 to 4, geometric centers of the orthographic projections of the support pillars 33 on the base substrate 31 coincide substantially with the geometric centers of the orthographic projections of the light-shielding patterns BP on the base substrate 31.

As shown in FIG. 5, diagram a illustrates a schematic diagram of a planar structure of the support pillars, diagram b illustrates a cross-sectional electron micrograph of one display substrate, and diagram b illustrates a cross-sectional electron micrograph of another display substrate.

In some implementations, as shown in FIG. 5, the support pillars 33 includes an inner pillar 33N and an outer pillar 33W, the outer pillar 33W is provided around a periphery of the inner pillar 33N, the outer pillar 33W is provided close to a side surface of the support pillar 33, and a density of the outer pillar 33W is smaller than that of the inner pillar 33N.

Exemplarily, a cross-sectional roughness of the outer pillar 33W is greater than a cross-sectional roughness of the inner pillar 33N, as shown in diagrams b or c in FIG. 5.

Exemplarily, as shown in diagram a in FIG. 5, the outer pillar 33W is an annular pillar, which may be coaxially disposed with the inner pillar 33N, and a side surface of the outer pillar 33W away from the inner pillar 33N may be, for example, a side surface of the support pillars 33.

Exemplarily, as shown in diagram a in FIG. 5, in orthographic projections on the base substrate 31, a radius w0 of the inner pillar 33N is greater than a thickness W1 of the outer pillar 33W. For example, the thickness W1 of the outer pillar 33W may be greater than or equal to 50 nanometers and less than or equal to 100 nanometers.

Exemplarily, transverse etching may be used, so that the edges of the support pillars 33 are indented with respect to the edges of the light-shielding patterns BP. At a transverse indentation rate of 20 angstroms/second and a transverse indentation amount d of 0.8 micrometers, the etching duration is about 400 seconds. During the long etching process, a rough structure is formed on the side surface layer of the support pillars 33 due to the bombardment effect of the etching gas on the support pillars 33 and carbonization effect of the surface material.

Therefore, the thickness W1 of the outer pillar 33W is related to the etching duration. The longer the etching duration, the greater the thickness W1 of the outer pillar 33W.

In the implementation, the rough outer pillar 33W may block the etching gas from further etching inwardly, so the longer the etching duration, the slower the etching rate, which is conducive to accurately controlling the indentation amount of the edges of the support pillars 33 with respect to the edges of the light-shielding patterns BP.

In some implementations, as shown in diagram b or c in FIG. 5, the support pillars 33 include a boss 51 disposed at an edge of a surface of the support pillars 33 away from the base substrate 31, and the boss 51 is recessed toward a side close to the base substrate 31.

Exemplarily, the boss 51 is located at a position where the surface of the support pillars 33 away from the base substrate 31 intersects the side surface of the support pillars 33, as shown by the circular dashed box in FIG. 5.

In some implementations, as shown by the rectangular dashed box in FIG. 5, the support pillars 33 includes a slit 52 close to a position where side surfaces of the support pillars 33 intersect the first surface SF1.

In some implementations, as shown in FIG. 6, the support pillars 33 include a plurality of sub-pillars 60 stacked sequentially in the first direction f1, at least two sub-pillars 60 have different features including at least one of a size of holes on the side surface of the sub-pillars 60, a density of holes on the side surface of the sub-pillars 60, a lateral inclination angle of the sub-pillars 60, and a size of the sub-pillars 60 in the second direction f2. The lateral inclination angle is an angle between the side surface of the sub-pillars 60 and the first direction f1, and the second direction f2 is perpendicular to the first direction f1.

The size of the hole on the side surface of the sub-pillars 60 are the diameters of the holes located on the side surface of the sub-pillars 60. The density of holes on the side surface of the sub-pillars 60 refers to the number of holes per unit area on the side surface of the sub-pillars 60.

Exemplarily, the size of holes may be measured by an instrument such as a scanning electron microscope (SEM).

Exemplarily, the density of holes may be measured by an instrument such as a specific surface area hole diameter analyzer, and may also be calculated based on a ratio of the number of holes on the side surface of the sub-pillars 60 to the side surface area.

Exemplarily, as shown in FIG. 6, the plurality of sub-pillars 60 include a first sub-pillar 61, a second sub-pillar 62, and a third sub-pillar 63. The first sub-pillar 61 is disposed close to the base substrate 31, the third sub-pillar 63 is disposed away from the base substrate 31, and the second sub-pillar 62 is disposed between the first sub-pillar 61 and the third sub-pillar 63.

In some implementations, as shown in FIG. 6, the size of holes on the side surface of the second sub-pillar 62 is greater than or equal to a size of holes on the side surface of the first sub-pillar 61, and the size of holes on the side surface of the first sub-pillar 61 is greater than or equal to the size of holes on the side surface of the third sub-pillar.

Exemplarily, the size of holes on the side surface of the first sub-pillar 61 may be greater than or equal to 30 nanometers and less than or equal to 50 nanometers. The size of holes on the side surface of the second sub-pillar 62 may be greater than or equal to 30 nanometers and less than or equal to 50 nanometers. The size of holes on the side surface of the third sub-pillar 63 may be greater than or equal to 10 nanometers and less than or equal to 30 nanometers.

In particular implementations, transverse etching may be used, so that the edges of the support pillars 33 are indented with respect to the edges of the light-shielding patterns BP. During the etching process, the top of the support pillars 33 is shielded by the mask pattern 114, the mask pattern 114 produces a light-shielding effect, so that holes with small diameters on the side surface of the third sub-pillar 63 near the top are formed. The etching effect is strongest at the middle of the support pillars 33, so that holes with large diameters are formed on the side surface of the second sub-pillars 62 near the middle. In addition, the light-shielding patterns BP provided at the bottom of the support pillars 33 produce a slight light-shielding effect, and therefore, the size of holes on the side surface of the first sub-pillar 61 near the bottom is between that of the second sub-pillar 62 and that of the third sub-pillar 63.

In some implementations, as shown in FIG. 6, the density of holes on the side surface of the second sub-pillar 62 is less than or equal to the density of holes on the side surface of the first sub-pillar 61, and the density of holes on the side surface of the first sub-pillar 61 is less than or equal to the density of holes on the side surface of the third sub-pillar 63.

Exemplarily, the density of holes on the side surface of the first sub-pillar 61 may be greater than or equal to 20 holes per square micrometer and less than or equal to 30 holes per square micrometer. The density of holes on the side surface of the second sub-pillar 62 may be greater than or equal to 20 holes per square micrometer and less than or equal to 30 holes per square micrometer. The density of holes on the side surface of the third sub-pillar 63 may be greater than or equal to 30 per square micrometer and less than or equal to 100 per square micrometer.

In some implementations, the lateral inclination angle of the sub-pillars 60 is greater than or equal to 0° and less than or equal to 30°.

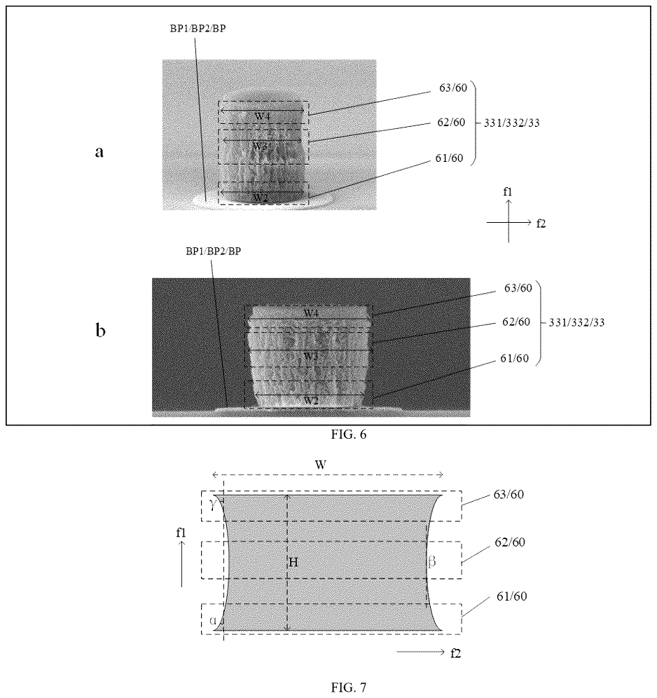

Exemplarily, as shown in FIG. 7, the lateral inclination angle of the sub-pillars 60 may be a lateral inclination angle α of the first sub-pillar 61, may also be a lateral inclination angle βof the second sub-pillar 62, and may also be a lateral inclination angle γ of the third sub-pillar 63.

In some implementations, as shown in FIG. 7, the lateral inclination angle β of the second sub-pillar 62 is less than or equal to the lateral inclination angle α of the first sub-pillar 61, and the lateral inclination angle α of the first sub-pillar 61 is less than or equal to the lateral inclination angle γ of the third sub-pillar 63.

Exemplarily, the lateral inclination angle β of the second sub-pillar 62 is greater than or equal to 0° and less than or equal to 3. In FIG. 7, the lateral inclination angle β of the second sub-pillar 62 is 0°. The lateral inclination angle α of the first sub-pillar 61 is greater than or equal to 5° and less than or equal to 30°. The lateral inclination angle γ of the third sub-pillar 63 is greater than or equal to 5° and less than or equal to 30°.

In a specific implementation, there are various relationships among the size W2 of the first sub-pillar 61 in the second direction f2, the size W3 of the second sub-pillar 62 in the second direction f2, and the size W4 of the third sub-pillar 63 in the second direction f2, which are illustrated exemplarily below.

In some examples, as shown in diagram a in FIG. 6, the size W3 of the second sub-pillar 62 in the second direction f2 is less than or equal to the size W2 of the first sub-pillar 61 in the second direction f2, and the size W2 of the first sub-pillar 61 in the second direction f2 is less than or equal to the size W4 of the third sub-pillar 63 in the second direction f2.

In this example, as shown in the diagram a in FIG. 6, the support pillars 33 have a structure that is narrow in the middle and wider at the top and bottom.

In other examples, as shown in diagram b in FIG. 6, the size W2 of the first sub-pillar 61 in the second direction f2 is less than or equal to the size W3 of the second sub-pillar 62 in the second direction f2, and the size W3 of the second sub-pillar 62 in the second direction f2 is less than or equal to the size W4 of the third sub-pillar 63 in the second direction f2.

In this example, the support pillars 33 have a structure that is wider at the top and narrows downwardly, as shown in diagram b in FIG. 6. The shape of the longitudinal cross-section (a cross-section parallel to the first direction f1) of the support pillars 33 is substantially a trapezoid, and short sides of the trapezoid is disposed close to the light-shielding patterns BP.

Exemplarily, as shown in the diagram b in FIG. 6, a ratio of the size W4 of the third sub-pillar 63 in the second direction f2 to the size W2 of the first sub-pillar 61 in the second direction f2 is greater than or equal to 1. For example, the size W4 of the third sub-pillar 63 in the second direction f2 is 1 micrometer, and the size W2 of the first sub-pillar 61 in the second direction f2 may be greater than or equal to 0.8 micrometers, or less than 1 micrometers.

In some implementations, in orthographic projections on the base substrate 31, the ratio of the minimum distance d (as shown in FIG. 4) between the edges of the support pillars 33 and the edges of the light-shielding patterns BP, to the height H (shown in FIG. 7) of the support pillars 33 in the first direction f1, is greater than or equal to 1/1.2, and less than or equal to 1.

In the orthographic projections on the base substrate 31, the minimum distance d between the edges of the support pillars 33 and the edges of the light-shielding patterns BP may be an indentation amount d of the edges of the support pillars 33 with respect to the edges of the light-shielding patterns BP.

Since the height H of the support pillars 33 in the first direction f1 and the size W of the support pillars 33 in the second direction f2 affect the light leakage distance LLD2, the value of the indentation amount d is related to the height H of the support pillars 33 in the first direction f1 and the size W of the support pillars 33 in the second direction f2. When the height H of the support pillars 33 in the first direction f1 is 1.1 micrometers and the size W of the support pillars 33 in the second direction f2 is 4 micrometers, the indentation amount d of 0.8 micrometers is sufficient to block the light leakage.

In a high-resolution display substrate (e.g., a resolution of 2000 PPI or more), the size W of the support pillars 33 in the second direction f 2 is much less than 4 micrometers, and the light leakage distance LLD 2 is mainly determined by the height H of the support pillars 33 in the first direction f1. It is founded that when the ratio of the indentation amount d (i.e., the minimum distance between the edges of the support pillars 33 and the edges of the light-shielding patterns BP) to the height H of the support pillars 33 in the first direction f 1 is greater than or equal to 1/1.2 and less than or equal to 1, light leakage may be blocked.

In some implementations, as shown in FIG. 7, the ratio of the size W of the support pillars 33 in the second direction f2 to the height H of the support pillars 33 in the first direction f1 is greater than or equal to 1/1.3, and the second direction f2 is perpendicular to the first direction f1. In this way, the support pillars 33 may be avoided from falling off when subjected to an external force.

Exemplarily, the light-shielding patterns BP and the support pillars 33 are formed by the self-alignment process, and the size W of the support pillars 33 in the second direction f2 may be determined by the size of the light-shielding patterns BP in the second direction f2, and the indentation amount d of the edges of the support pillars 33 with respect to the edges of the light-shielding patterns BP.

Exemplarily, the maximum size of the support pillars 33 in the second direction f2 is 1 micrometers, and the height H of support pillars 33 in the first direction f1 is less than or equal to 1.3 micrometers.

In some implementations, as shown in FIG. 7, the size W of the support pillars 33 in the second direction f2, which is perpendicular to the first direction f1, is greater than or equal to 0.8 micrometers and less than or equal to 3 micrometers.

In the high-resolution display substrate, in order to ensure that the liquid crystal molecules 13 have a high response speed, the liquid crystal cell gap is, for example, 1.6 micrometers, and the height H of the support pillars 33 in the first direction f1 may be set to be greater than or equal to 1.0 micrometers and less than or equal to 1.6 micrometers. In some implementation, the host material of the light-shielding layer 32 is a metal

material. For example, the host material of the light-shielding layer 32 is molybdenum, and the material molybdenum may further reduce depolarization light leakage of the display substrate.

In the present disclosure, the support pillars 33 may be the first support pillar 331 or the second support pillar 332, and the present disclosure is not limited thereto.

In some implementation, as shown in FIG. 2, the first support pillars 331 includes a third surface S1 which is a surface of the first support pillar 331 away from the base substrate 31, the second support pillar 332 includes a fourth surface S2 which is a surface of the second support pillar 332 away from the base substrate 31, and the roughness of the third surface S1 (the upper surface roughness of the support pillars 33 shown in diagram b in FIG. 5) is less than or equal to the roughness of the fourth surface S2 (the upper surface roughness of the support pillars 33 as shown in diagram b in FIG. 5).

Since the height H2 of the second support pillar 332 in the first direction f1 is smaller than the height H1 of the first support pillar 331 in the first direction f1, in a specific implementation, the surface of the second support pillar 332 away from the base substrate 31 may be longitudinally etched to form a height difference between the first support pillar 331 and the second support pillar 332, so that the surface of the second support pillar 332 away from the base substrate 31, i.e., the fourth surface S2, has a higher roughness.

In some implementation, as shown in FIG. 3, in orthographic projections on the base substrate 31, the minimum distance between the edges of the first support pillar 331 and the edge of the light-shielding patterns BP is substantially equal to the minimum distance between the edge of the second support pillar 332 and the edges of the light-shielding patterns BP.

As shown in FIG. 3, the plurality of light-shielding patterns BP include a first light-shielding pattern BP1 and a second light-shielding pattern BP2. In the orthographic projections on the base substrate 31, the first support pillar 331 is located in a region of the first light-shielding pattern BP1, and the second support pillar 332 is located in the region of the second light-shielding pattern BP2.

In the present implementation, the minimum distance between the edge of the first support pillar 331 and the edges of the light-shielding patterns BP, i.e., the indentation amount of the edge of the first support pillar 331 with respect to an edge of the first light-shielding pattern BP 1. The minimum distance between the edge of the second support pillar 332 and the edges of the light-shielding patterns BP, that is, the indentation amount of the edge of the second support pillar 332 with respect to the edges of the light-shielding patterns BP 2, is the minimum distance between the edge of the second support pillar 332 and the edge of the second light-shielding pattern BP 2.

As shown in FIG. 3, in the orthographic projections on the base substrate 31, the indentation amount of the edge of the first support pillar 331 with respect to the edge of the first light-shielding pattern BP1 is equal to the indentation amount of the edge of the second support pillar 332 with respect to the edge of the second light-shielding pattern BP2.

Exemplarily, as shown in FIG. 3, the orthographic projections of the first light-shielding pattern BP1 and the second light-shielding pattern BP2 on the base substrate 31 are substantially the same in the shape and size.

Exemplarily, as shown in FIG. 3, the orthographic projections of the first support pillar 331 and the second support pillar 332 on the base substrate 31 are substantially the same in the shape and size.

In some implementations, the display substrate includes a plurality of sub-pixels arranged in an array. As shown in FIG. 2 or FIG. 3, the plurality of sub-pixels may include a red sub-pixel R, a green sub-pixel G, and a blue sub-pixel B.

In some implementation, the number of sub-pixels located between two adjacent first support pillars 331 is greater than or equal to 10 and less than or equal to 20.

Exemplarily, the number of sub-pixels located between two adjacent first support pillars 331 is 15, i.e., every 15 sub-pixels are provided for one first support pillar 331.

In some implementations, the number of sub-pixels located between two adjacent second support pillars 332 is greater than or equal to 1 and less than or equal to 2.

Exemplarily, the number of sub-pixels located between two adjacent second support pillars 332 is 1, i.e., 1 sub-pixel is provided for one second support pillar 332.

Exemplarily, as shown in FIG. 2, the display substrate may further include a black matrix 34, a filtering layer 35, a flattening layer 36, and a buffer Layer 37 stacked sequentially between the base substrate 31 and the light-shielding layer 32. The black matrix 34 is disposed close to the base substrate 31. The light-shielding layer 32 is disposed on a side of the buffer layer 37 away from the base substrate 31. The filtering layer 35 includes, for example, a red filter pattern in the red sub-pixel R, a green filter pattern in the green sub-pixel G, and a blue filter pattern in the blue sub-pixel B.

Exemplarily, as shown in FIG. 3, the orthographic projection of the light-shielding layer 32 on the base substrate 31 overlaps with the orthographic projection of the black matrix 34 on the base substrate 31.

Exemplarily, as shown in FIG. 3, the orthographic projection of the light-shielding layer 32 on the base substrate 31 is within the orthographic projection of the black matrix 34 on the base substrate 31.

As shown in FIG. 8, the present disclosure also provides a display panel including a cell substrate 81, a liquid crystal layer 82, and a display substrate 83 as provided in any implementation. The liquid crystal layer 82 is between the counter-box substrate 81 and the display substrate 83, and the support pillars 33 are disposed close to the liquid crystal layer 82. The cell substrate 81 includes a cell base 811, and a plurality of bosses PW disposed on

a side of the cell substrate 811 close to the liquid crystal layer 82, and the plurality of bosses PW are disposed opposite to different support pillars 33, respectively.

Those skilled in the art would understand that the display panel provided by the present disclosure has the advantages of the above display substrate 83.

Exemplarily, the plurality of bosses PW includes a first boss PW1 opposite to the first support pillar 331 and a second boss PW2 opposite to the second support pillar 332. The heights of the first boss PW1 and the second boss PW2 in the first direction f1 may be the same.

After the alignment of the cell substrate 81 and the display substrate 83, as shown in FIG. 8, the first boss PW1 and the first support pillar 331 come into contact with each other to ensure the cell gap. In this case, the second support pillar 332 is in a suspended state and does not come into contact with the second boss PW2.

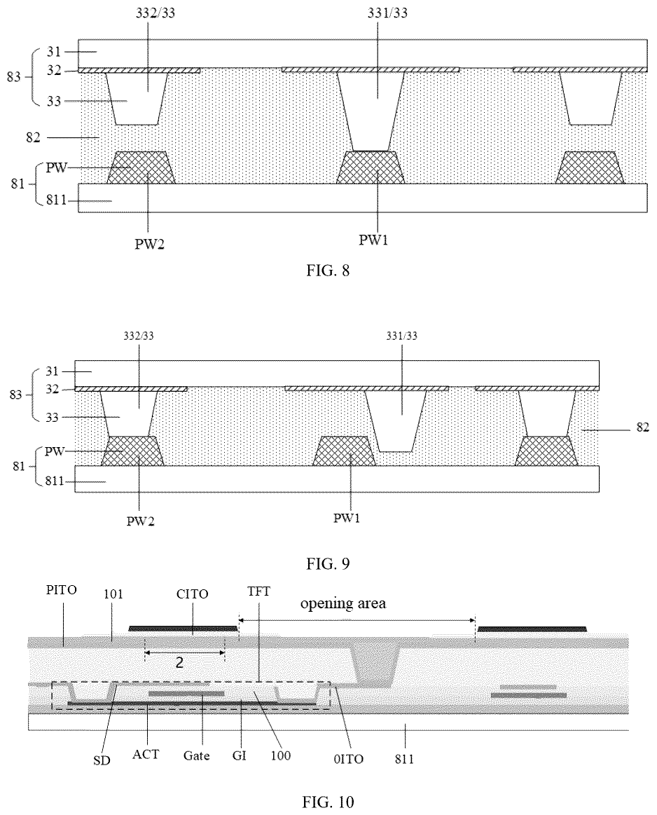

When the display panel is subjected to an external force, for example, the display panel is carried or pressed, as shown in FIG. 9, the first boss PW1 and the first support pillar 331 are misaligned, and the second support pillar 332 comes into contact with the second boss PW2, thereby serving as an auxiliary support to ensure that adverse phenomena such as scratches, black gaps, etc does not appear in the display panel.

Exemplarily, the ratio of the total surface area of the support pillars 33 close to the cell substrate 81 to the area of the sub-pixel is defined as contact density, the contact density of the first support pillar 331 may be greater than or equal to 200, and less than or equal to 300, and the contact density of the second support pillar 332 may be, for example, 20,000.

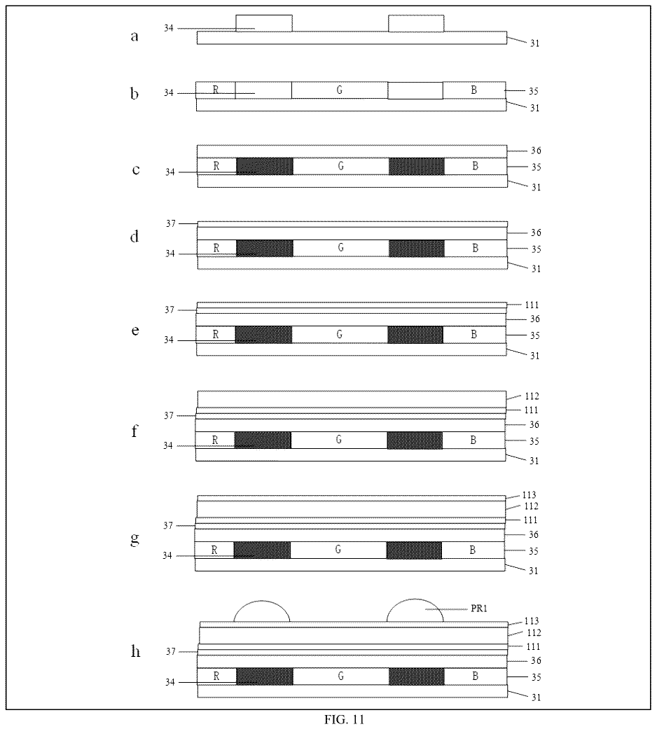

Exemplarily, as shown in FIG. 10, the cell substrate 81 of each sub-pixel may further include a thin film transistor TFT, an organic layer PL1, a pixel electrode PITO, an insulating layer 101, and a common electrode CITO stacked sequentially between the cell substrate 811 and the boss PW. The thin film transistor TFT is disposed close to the cell substrate 811 and includes an active layer ACT, a gate insulating layer GI, a gate Gate, an insulating layer 100, a source SD, and a drain OITO stacked sequentially. The active layer ACT is disposed close to the cell base 811. The source SD and the drain OITO are disposed in the same layer. The pixel electrode PITO and the drain OITO are connected through a via disposed on the organic layer PL1.

Exemplarily, the material of the active layer ACT may include a semiconductor material such as amorphous silicon, low temperature polysilicon, or a metal oxide. The metal oxide may include one or more of indium gallium zinc oxide (IGZO), indium gallium tin oxide (IGTO), indium tin zinc oxide (ITZO), indium gallium oxide (IGO), indium gallium zinc tin oxide (IGZTO), and rare earth doped oxide (Ln-OS). The material of the active layer ACT may be amorphous, partially crystalline, single crystal or polycrystalline, and the film layer may be single-layer or multi-layer structure.

Exemplarily, the boss PW may be formed synchronously with the thin film transistor TFT, the organic layer PL1, the pixel electrode PITO, the insulating layer 101, and/or the common electrode CITO.

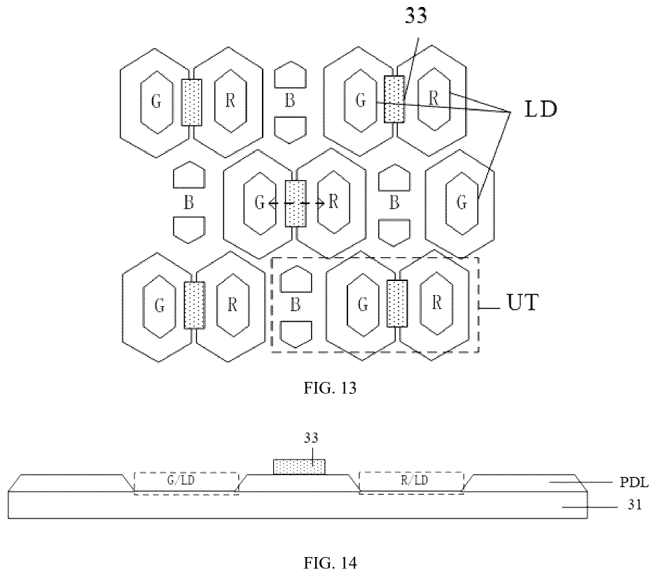

As shown in FIGS. 13 and 14, the present disclosure also provides a display panel, including a display substrate as provided in any implementation; and a plurality of light-emitting devices LDs. The support pillars 33 are disposed between two adjacent light-emitting devices LDs in the orthographic projections on the base substrate 31.

Those skilled in the art would appreciate that the display panel provided by the present disclosure has the advantages of the above display substrate.

Exemplarily, the plurality of light-emitting devices may include a red light-emitting device LDR, a green light-emitting device LDG, and a blue light-emitting device LDB.

Exemplarily, the display panel includes a plurality of pixel units UT arranged in an array in a row direction and a column direction. The pixel units UT include at least one red light-emitting device LDR, at least one green light-emitting device LDG, and at least one blue light-emitting device LDB. In FIG. 13, the pixel units UT include a red light-emitting device LDR, two green light-emitting devices LDG, and a blue light-emitting device LDB.

Exemplarily, the support pillars 33 may be disposed between the red light-emitting device LDR and the blue light-emitting device LDB, and the present disclosure is not limited thereto.

Exemplarily, a pixel defining layer PDL may be disposed between the base substrate 31 and the support pillars 33. The pixel defining layer PDL is configured to form a plurality of pixel openings, and the pixel openings are configured to dispose the light-emitting device LD.

Exemplarily, heights of different support pillars 33 in the first direction f1 may be the same or different, and the present disclosure is not limited thereto.

Exemplarily, the light-emitting device LD may be an organic light-emitting diode (OLED), a quantum dot light-emitting diode (QLED), a mini light-emitting diode (Mini LED), or a micro light-emitting Diode (Micro LED), etc.

The present disclosure also provides a display apparatus including a display panel as provided in any implementation and a driving component connected to the display panel for driving the display panel to display a picture.

Those skilled in the art would understand that the display apparatus provided by the present disclosure has the advantages of the above display panel.

The display apparatus provided by the present disclosure may be a display module, a cell phone, a tablet computer, a television, a monitor, a laptop computer, a digital photo frame, an in-vehicle display apparatus, a smartwatch, a fitness wristband, a personal digital assistant, and any other product or component with a display function.

Exemplarily, for the liquid crystal display panel, the display module may further include a backlight module disposed on a backlight side of the display panel for providing a backlight to the display panel.

The present disclosure also provides a preparation method of a display substrate, including:
step S01: providing a base substrate 31; and
step S02: forming a light-shielding layer 32 and a plurality of support pillars 33 on a side of the base substrate 31 to obtain a display substrate as shown in FIG. 2 or FIG. 3. As shown in FIGS. 2 and 3, the plurality of support pillars 33 are provided on a surface of the light-shielding layer 32 away from the base substrate 31. The light-shielding layer 32 includes a plurality of light-shielding patterns BP. In orthographic projections on the base substrate 31, different support pillars 33 are located in regions of different light-shielding patterns BP, and the support pillars 33 and the light-shielding patterns BP overlapping with each other have substantially the same shape. The plurality of support pillars 33 include a first support pillar 331 and a second support pillar 332, the height H1 of the first support pillar 331 in the first direction f1 is greater than the height H2 of the second support pillar 332 in the first direction f1, and the first direction f1 is a direction from the base substrate 31 to the light-shielding layer 32.

The display substrate provided in any one of the above implementations may be prepared by the preparation method provided in the present disclosure.

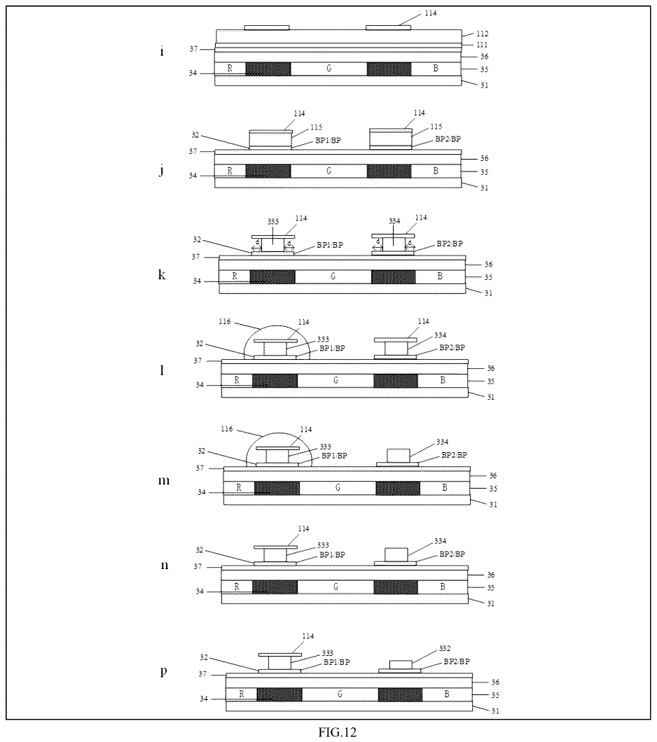

In some implementation, as shown in FIGS. 11 to 12, the step S02 may specifically include:
step S101: forming a light-shielding film 111 on a side of the base substrate 31.

Exemplarily, a black matrix 34 may first be formed on aside of the base substrate 31 as shown in diagram a in FIG. 11. As shown in diagram b in FIG. 11, a filtering layer 35 is formed on a side of the black matrix 34 away from the base substrate 31. As shown in diagram b in FIG. 11, a flattening layer 36 is formed on a side of the filtering layer 35 away from the base substrate 31, and the flattening layer 36 may flattens the segment differences on the surface of the filtering layer 35 to ensuring subsequent etching homogeneity of the light-shielding patterns BP and the support pillars 33. The filtering layer 35 may use a conventional material or a material with high color gamut and low film thickness.

In order to ensure that the flattening layer 36 is not damaged during the subsequent etching process, a buffer layer 37 may be formed on a side of the flattening layer 36 away from the base substrate 31, as shown in diagram d in FIG. 11, and the material of the buffer layer 37 may include, for example, silicon nitride, silicon oxide, etc.

In this example, as shown in diagram e in FIG. 11, the light-shielding film 111 is provided on a side of the buffer layer 37 away from the base substrate 3. The film thickness of the light-shielding film 111 may be, for example, 500 angstroms, and the material is molybdenum. The reflectivity of the light-shielding film 111 may be, for example, 60%.

In step S102, a support film 112 is formed on a side of the light-shielding film 111 away from the base substrate 31, as shown in diagram f in FIG. 11.

Exemplarily, the support film 112 may be made of a photo-reactive material or an acrylic material. After the support film 112 is formed, the support film 112 may be photocured to improve the adhesion of the support film 112.

In step S103, a mask pattern 114 is formed on a side of the support film 112 away from the base substrate 31 by a patterning process, as shown in diagram i in FIG. 12.

Exemplarily, the material of the mask pattern 114 may be, for example, a metal material such as molybdenum, a metal oxide material such as indium tin oxide, and an inorganic insulating material such as silicon nitride or silicon oxide.

When the material of the light-shielding film 111 is molybdenum and the material of the buffer layer 37 is silicon nitride or silicon oxide, the material of the mask pattern 114 may be a metal oxide such as indium tin oxide in order to form an etching difference.

Exemplarily, in step S103, as shown in diagrams g to i in FIG. 11, an indium tin oxide film 113 may first be formed on aside of the support film 112 away from the base substrate 31, and then the indium tin oxide film 113 may be photolithographed by the mask to form a mask pattern 114.

In step S104, the support film 112 not covered with the mask pattern 114 is etched to form a plurality of support patterns 115, as shown in diagram j in FIG. 11.

Exemplarily, the etching atmosphere may be selected from oxygen, and the etching duration may be 50 s, for example.

In step S105, the light-shielding film 111 not covered with the mask pattern 114 is etched to form a plurality of light-shielding patterns BP to obtain the light-shielding layer 32, as shown in diagram j in FIG. 11.

Exemplarily, the etching atmosphere may be selected as a mixture of oxygen and chlorine, and the etching duration may be, for example, 40s.

Exemplarily, orthographic projections of the light-shielding patterns BP and the support patterns 115 on the base substrate 31 may completely overlap.

In step S106, the plurality of support patterns 115 are transversely etched to form a third support pillar 333 and a fourth support pillar 334, as shown in diagram k FIG. 11, so that both the third support pillar 333 and the fourth support pillar 334 are indented with respect to their respective corresponding light-shielding patterns BP, and the indentation amount d is the same, for example, 0.8 micrometers.

Exemplarily, the etching atmosphere may be selected from oxygen, and the etching duration may be, for example, 100s.

In step S107, a protective film 116 is covered on a side of the third support pillar 333, the mask pattern 114 connected with the third support pillar 333, and the light-shielding pattern BP connected with the third support pillar 333 away from the base substrate 31, as shown in diagram 1 in FIG. 11.

Exemplarily, after a layer of photoresist may first be formed on the display substrate in the step S106, the photoresist is exposed and developed by the mask to retain only the photoresist disposed on the side of the third support pillar 333, the mask pattern 114 connected with the third support pillar 333, and the light-shielding pattern BP connected with the third support pillar 333 away from the base substrate 31, thereby forming the protective film 116.

It should be noted that since the protective film 116 is removed in a subsequent process, the mask for forming the protective film 116 does not affect the sizes of the light-shielding patterns BP and does not introduce additional alignment errors.

In step S108, a mask pattern 114 connected with a fourth support pillar 334 is removed, as shown in diagram m in FIG. 11.

Exemplarily, the mask pattern 114 on the fourth support pillar 334 is removed by the etching process.

In step S109, the protective film 116 is removed, as shown in diagram n in FIG. 11.

Exemplarily, in order to facilitate the removal of the protective film 116, the protective film 116 may not be deeply cured during the process of forming the protective film 116.

In step S110, the fourth support pillar 334 is longitudinally etched to obtain the second support pillar 332, as shown in diagram p in FIG. 11.

Exemplarily, the fourth support pillar 334 may be longitudinally etched by 0.5 micrometers to form a height difference of 0.5 micrometers between the second support pillar 332 and the first support pillar 331.

In step S111, the mask pattern 114 connected with the third support pillar 333 is removed to obtain the first support pillar 331, and the display substrate as shown in FIG. 2 is obtained.

Exemplarily, the mask pattern 114 on the third support pillar 333 is removed by an etching process.

Exemplarily, when the material of the support film 112 is acrylic, the longitudinal etching rate is about 200 angstroms/second and the transverse etching rate is about 20 angstroms/second. Thus, when the longitudinal etching depth is 0.5 micrometers, the etching duration is 25 s. Since the transverse etching rate is much smaller than the longitudinal etching rate, the transverse etching depth of the first support pillar 331 and the second support pillar 332 during the longitudinal etching is only 0.05 micrometers, which may be ignored.

In this implementation, the light-shielding patterns BP and the support pillars 33 are prepared by the self-alignment process, i.e., the light-shielding layer 32 and the support pillars 33 are exposed and etched by the same mask. Compared with the process in which the light-shielding layer 32 and the support pillars 33 are photolithographed by different masks, the self-alignment process may save a mask process, simplifies the preparation process, and reduces the cost. In the self-alignment process, transverse etching may be used, so that the edges of the support pillars 33 are indented with respect to the edges of the light-shielding patterns BP.

In addition, the self-alignment process may also avoid alignment between the light-shielding patterns BP and the support pillars 33, thereby eliminating the alignment tolerance ol2, further reducing the transverse size BP CD2 of the light-shielding patterns BP, and improving the aperture rate and the light transmission of the display substrate.

1. A display substrate, comprising:
a base substrate; and
a plurality of support pillars disposed on a side surface of the base substrate, wherein the support pillars have a first surface close to the base substrate and a second surface opposite to the first surface; and
in any direction parallel to the base substrate, a ratio of a width of the first surface to a width of the second surface is greater than or equal to 0.8 and less than or equal to 1.2, and the width of the first surface is greater than or equal to 0.8 micrometers and less than or equal to 3 micrometers.

2. The display substrate according to claim 1, wherein the plurality of support pillars comprises a first support pillar and a second support pillar, a height of the first support pillar in a first direction is greater than a height of the second support pillar in the first direction, and the first direction is a direction from the base substrate to the second surface of the support pillars.

3. The display substrate according to claim 2, wherein a light-shielding layer is disposed between the base substrate and the support pillars, and the light-shielding layer comprises a plurality of light-shielding patterns; and
an orthographic projection of at least one of the support pillars on the base substrate is located in an orthographic projection of one of the light-shielding patterns on the base substrate, and in orthographic projections on the base substrate, the support pillar are centrally disposed within the light-shielding patterns overlapping with the support pillars.

4. The display substrate according to claim 1, wherein the support pillars comprise:
an inner pillar and an outer pillar, the outer pillar is disposed around a periphery of the inner pillar, the outer pillar is disposed close to a side surface of the support pillars, and a density of the outer pillar is less than that of the inner pillar.

5. The display substrate according to claim 1, wherein the support pillars comprise:
a plurality of sub-pillars stacked sequentially in the first direction, at least two of the sub-pillars have different features comprising at least one of a size of holes on a side surface of the sub-pillars, a density of holes on the side surface of the sub-pillars, a lateral inclination angle of the sub-pillars, and a size of the sub-pillars in the second direction, the lateral inclination angle is an angle between the side surface of the sub-pillars and the first direction, the first direction is a direction from the base substrate to the second surface of the support pillars, and the second direction is perpendicular to the first direction; and
the plurality of sub-pillars comprises a first sub-pillar, a second sub-pillar and a third sub-pillar, the first sub-pillar is disposed close to the base substrate, the third sub-pillar is disposed away from the base substrate, and the second sub-pillar is disposed between the first sub-pillar and the third sub-pillar.

6. The display substrate according to claim 5, wherein a size of holes on a side surface of the second sub-pillar is greater than or equal to a size of holes on a side surface of the first sub-pillar, and the size of holes on the side surface of the first sub-pillar is greater than or equal to a size of holes size on a side surface of the third sub-pillar.

7. The display substrate according to claim 5 or 6, wherein a density of holes on the side surface of the second sub-pillar is less than or equal to a density of holes on the side surface of the first sub-pillar, and a density of holes on the side surface of the first sub-pillar is less than or equal to a density of holes on the side surface of the third sub-pillar.

8. The display substrate according to claim 5, wherein a lateral inclination angle of the second sub-pillar is less than or equal to a lateral inclination angle of the first sub-pillar, and the lateral inclination angle of the first sub-pillar is less than or equal to a lateral inclination angle of the third sub-pillar.

9. The display substrate according to claim 5, wherein the lateral inclination angle is greater than or equal to 0° and less than or equal to 30°.

10. The display substrate according to claim 5, wherein a size of the second sub-pillar in the second direction is less than or equal to a size of the first sub-pillar in the second direction, and the size of the first sub-pillar in the second direction is less than or equal to a size of the third sub-pillar in the second direction; or
the size the first sub-pillar in the second direction is less than or equal to the size of the second sub-pillar in the second direction, and the size of the second sub-pillar in the second direction is less than or equal to the size of the third sub-pillar in the second direction.

11. The display substrate according to claim 1, wherein the support pillars comprise at least one of:
a boss, disposed at an edge of a surface of the support pillars away from the base substrate, and recessed toward a side close to the base substrate; and
a slit, close to a position where the side surface of the support pillars intersects the first surface.

12. The display substrate according to claim 3, wherein in orthographic projections on the base substrate, a ratio of a minimum distance between an edge of the support pillars and an edge of the light-shielding patterns, to heights of the support pillars in the first direction, is greater than or equal to 1/1.2 and less than or equal to 1, and the first direction is a direction from the base substrate to the second surface of the support pillars.

13. (canceled)

14. The display substrate according to claim 3, wherein in orthographic projections on the base substrate, a minimum distance between an edge of the first support pillar and an edge of the light-shielding patterns is substantially equal to a minimum distance between an edge of the second support pillar and the edge of the light-shielding patterns.

15. The display substrate according to claim 1, wherein a height of the support pillars in the first direction is greater than or equal to 1.0 micrometers and less than or equal to 1.6 micrometers; and/or
a ratio of a size of the support pillars in the second direction to the height of the support pillars in the first direction is greater than or equal to 1/1.3; and
the first direction is a direction from the base substrate to the second surface of the support pillars, and the second direction is perpendicular to the first direction.

16. The display substrate according to claim 2, wherein the first support pillar comprises a third surface which is a surface of the first support pillar away from the base, the second support pillar comprises a fourth surface which is a surface of the second support pillar away from the base substrate, and a roughness of the third surface is less than or equal to a roughness of the fourth surface.

17. (canceled)

18. A display panel, comprising: a cell substrate, a liquid crystal layer, and the display substrate according to claim 1, wherein the liquid crystal layer is disposed between the cell substrate and the display substrate, and the support pillars are disposed close to the liquid crystal layer; and
the cell substrate comprises a cell base, and a plurality of bosses disposed on a side of the cell substrate close to the liquid crystal layer, and the plurality of bosses are disposed opposite different support pillars.

19. A display panel, comprising:
the display substrate according to claim 1; and
a plurality of light-emitting devices, wherein in orthographic projections on the base substrate, the support pillars are disposed between two adjacent light-emitting devices.

20. A display apparatus, comprising:
the display panel according to claim 18; and
a driving component, connected to the display panel and configured for driving the display panel to display a picture.

21. A preparation method of a display substrate, comprising:
providing a base substrate;
forming a light-shielding layer and a plurality of support pillars on a side of the base substrate, wherein the plurality of support pillars are disposed on a surface of the light-shielding layer away from the base substrate, the light-shielding layer comprises a plurality of light-shielding patterns, in orthographic projections on the base substrate, different support pillars are disposed in different light-shielding patterns, and shapes of the support pillars and the light-shielding patterns overlapping with each other are substantially the same shape, the plurality of support pillars comprise a first support pillar and a second support pillar, a height of the first support pillar in a first direction is greater than a height of the second support pillar in the first direction, and the first direction is a direction from the base substrate to the light-shielding layer.

22. The preparation method according to claim 21, wherein the forming the light-shielding layer and the plurality of support pillars on the side of the base substrate comprises:
forming a light-shielding film on a side of the base substrate;
forming a support film on a side of the light-shielding film away from the base substrate;
forming a mask pattern on a side of the support film away from the base substrate by a patterning process;
etching the support film not covered with the mask pattern to form a plurality of support patterns;
etching the light-shielding film not covered with the mask pattern to form a plurality of light-shielding patterns, so as to obtain the light-shielding layer;
transversely etching the plurality of support patterns to form a third support pillar and a fourth support pillar;
covering a protective film on a side of the third support pillar, a mask pattern connected with the third support pillar, and a light-shielding pattern connected with the third support pillar away from the base substrate;
removing the mask pattern connected with the fourth support pillar;
removing the protective film;
longitudinally etching the fourth support pillar to obtain the second support pillar; and
removing the mask pattern connected with the third support pillar to obtain the first support pillar.
